(19) United States
(12) Patent Application Publication
(10) Pub. No.: US 2005/0008291 A1
(43) Pub. Date: Jan. 13, 2005

(54) Optical wave-guide microstructured environment absorption cell

(76) Inventor: Dougas M. Baney, Los Altos, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/616,090

(22) Filed: Jul. 8, 2003

(51) Int. Cl. G02B 6/26; G01J 3/00

(52) U.S. Cl. 385/31; 356/300

(57) ABSTRACT

Embodiments in accordance with the invention provide an absorption environment cell having a first wave-guide, a holey wave-guide containing a selective absorption medium, and a second wave-guide. A first terminus of the holey wave-guide is coupled to a first terminus of the first wave-guide. A second terminus of the holey wave-guide is coupled to a first terminus of the second wave-guide.

### FIELD OF THE INVENTION

Embodiments in accordance with the invention relate to spectroscopy, and more particularly to an absorption environment cell for use in spectroscopy.

### BACKGROUND OF THE INVENTION

In one means of spectroscopy, an optical signal is propagated through a substance having a known property (e.g., absorption). The input and output optical signals are then compared to study the spectral properties of the optical signal (e.g., wavelength) and/or the light source (e.g., tuning profile). Similarly, in one means of chemical or biological analysis, an optical signal having a known spectral property (e.g., amplitude) is propagated through an unknown substance. The input and output optical signals are then compared to determine the identity of the substance. A typical apparatus and method utilized for propagating the optical signal through the desired substance comprises a gas or liquid absorption cell.

Referring to FIG. 1, an absorption environment cell 105 according to the conventional art is shown. The absorption environment cell 105 may be a gas absorption cell, a liquid absorption cell, or the like. As shown in FIG. 1, the absorption environment cell 105 comprises a first fiber optic cable 110, a plurality of lenses, mirrors and/or the like 115, 120, a selective absorption medium vessel 125, and a second fiber optic cable 130. The first fiber optic cable 110 may be attached (e.g., using connector 155) to a light source 135. The second fiber optic cable 130 may be attached (e.g., using connector 160) to a detector 140.

The light source 135 generates an optical signal, which propagates along the first fiber optic cable 110. The optical signal is launched at the terminus of the first fiber optic cable 110. The first lens, mirror and/or the like 115 focuses the launched optical signal into a collimated beam 150. The collimated beam 150 propagates through the selective absorption medium vessel 125. The selective absorption medium in the vessel 125 interacts with the optical signal, thereby changing one or more properties thereof. The second lens, mirror and/or the like 120 then focuses the collimated beam 150 for capture at a terminus of the second fiber optic cable 130. The captured optical signal propagates along the second fiber optic cable 130 wherein it is received by the detector 140. The detector 140 determines the amplitude (e.g., absorption), frequency (e.g., wavelength), phase, polarization, group delay, scattering, reflection, dispersion (e.g., bandwidth), and/or the like characteristic of the received optical signal.

Typically, a reference optical signal is also propagated from the light source 135 to the detector 140. The reference optical signal is typically propagated along a free space path or a fiber optic cable, which does not pass through the selective absorption medium. The reference signal is utilized to make differential measurements of characteristics of the received optical signal. However, the absorption environment cell 105, according to the conventional art, suffers from various deleterious effects, such as alignment errors 135, reflection 145, 146 and the like.

### SUMMARY OF THE INVENTION

Embodiments in accordance with the invention provide an absorption environment cell having a first wave-guide, a holey wave-guide containing a selective absorption medium, and a second wave-guide. A first terminus of the holey wave-guide is coupled to a first terminus of the first wave-guide. A second terminus of the holey wave-guide is coupled to a first terminus of the second wave-guide.

### BRIEF DESCRIPTION OF THE DRAWINGS

The present invention is illustrated by way of example and not by way of limitation, in the figures of the accompanying drawings and in which like reference numerals refer to similar elements and in which:

Prior Art FIG. 1 shows an absorption environment cell according to the conventional art.

FIG. 2A shows an absorption environment cell, in one embodiment in accordance with the invention.

FIG. 2B shows a cross section view of an exemplary holey fiber optic cable, in one embodiment in accordance with the invention.

FIG. 3A shows an exemplary coupling of a first fiber optic cable, holey fiber optic cable and second fiber optic cable of an absorption environment cell, in one embodiment in accordance with the invention.

FIG. 3B shows a cross section view of an exemplary holey fiber optic cable, in one embodiment in accordance with the invention.

FIG. 4 shows a block diagram of a system for performing spectroscopy, in one embodiment in accordance with the invention.

FIG. 5 shows a block diagram of another system for performing spectroscopy, in one embodiment in accordance with the invention.

FIG. 6 shows a flow diagram of a method of performing spectroscopy, in one embodiment in accordance with the invention.

FIG. 7 shows a flow diagram of a method of chemical analysis, in one embodiment in accordance with the invention.

### DETAILED DESCRIPTION OF THE INVENTION

Reference will now be made in detail to the embodiments in accordance with the invention, examples of which are illustrated in the accompanying drawings. While the invention will be described in conjunction with these embodiments, it will be understood that they are not intended to limit the invention to these embodiments. Furthermore, in the following detailed description of embodiments in accordance with the invention, numerous specific details are set forth in order to provide a thorough understanding. However, it is understood that the embodiments in accordance with the invention may be practiced without these specific details. In other instances, well-known methods, procedures, components, and circuits have not been described in detail as not to unnecessarily obscure aspects of embodiments in accordance with the invention.

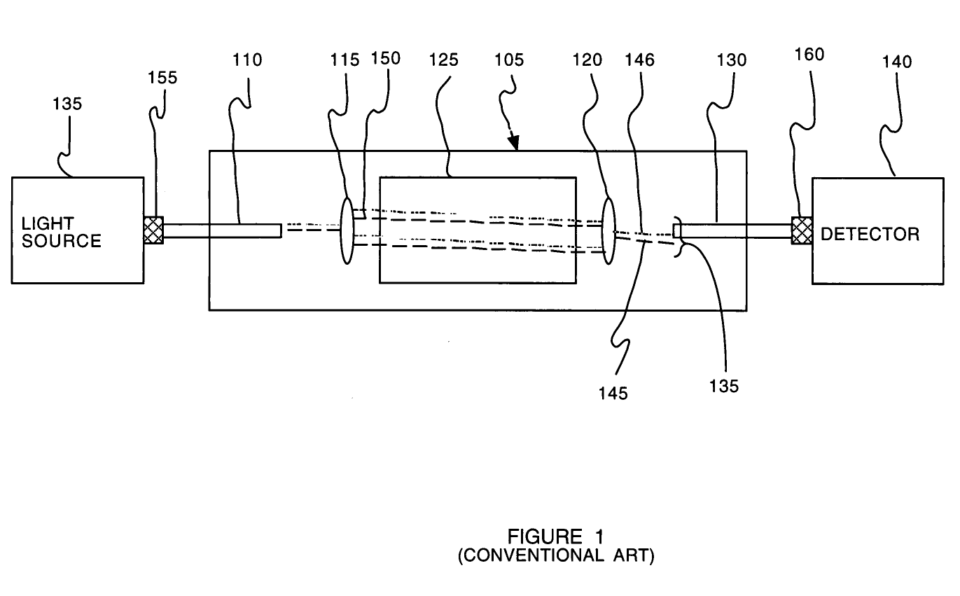

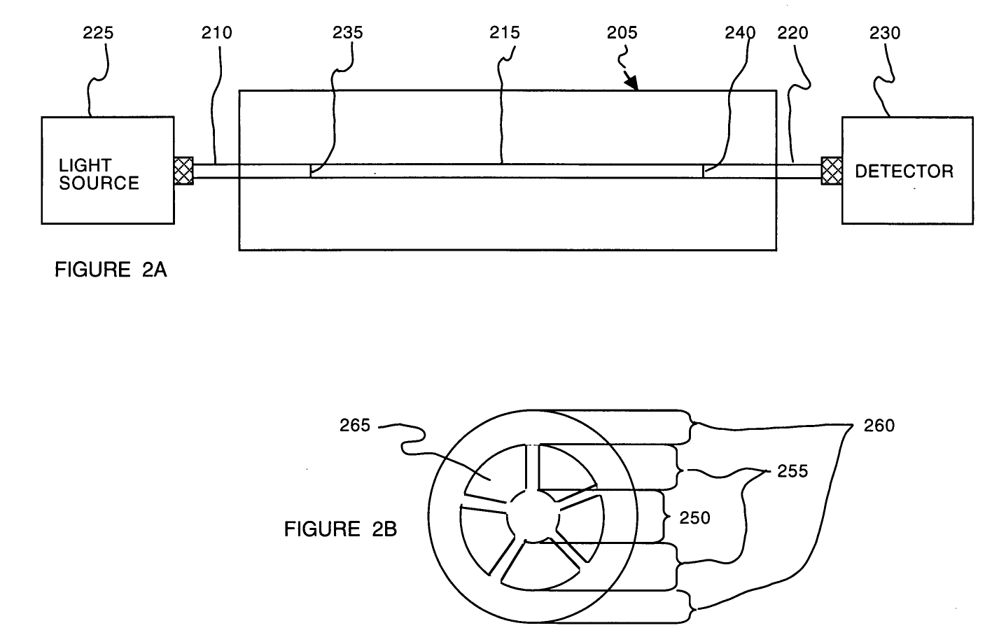

Referring to FIG. 2A, an absorption environment cell 205, in one embodiment in accordance with the invention, is shown. The absorption environment cell 205 is a gas absorption cell, a liquid absorption cell, or the like. As shown in FIG. 2A, the absorption environment cell 205 comprises a first wave-guide 210, a holey (e.g., microstructures) wave-guide 215, and a second wave-guide 220. The first wave-guide 210, the holey wave-guide 215 and the second wave-guide 220 may comprise fiber optic cables, planar wave-guides, photonic crystal guides, or the like.

In one embodiment in accordance with the invention, a holey fiber optic cable 215 comprises a core having a plurality of voids. The voids are substantially uniformly distributed along the length of the core. The voids are adapted to contain a selective absorption medium. The size and density of the voids are such that the optical signal couples to the selective absorption medium while maintaining the structural integrity of the holey fiber optic cable 215.

In one embodiment in accordance with the invention, a first terminus of a first fiber optic cable 210 is attached at location 235 to a first terminus of the holey fiber optic cable 215. A second terminus of the holey fiber optic cable 215 is attached at location 240 to a first terminus of a second fiber optic cable 220. Attaching of the holey fiber optic cable 215 to the first fiber optic cable 210 at location 235, and attaching of the holey fiber optic cable 215 to the second fiber optic cable 220 at location 240 is provided by an adhesive such as a light transmitting epoxy, or with a fusion splice, or the like.

In one embodiment in accordance with the invention, the first fiber optic cable 210 is coupled to a light source 225. The light source 225 generates an optical signal, which is propagated along the first fiber optic cable 210. The optical signal propagating in the first fiber optic cable 210 is coupled to the holey fiber optic cable 215. The optical signal in the holey fiber optic cable 215 propagates through the selective absorption medium contained therein. The optical signal propagating in the holey fiber optic cable 215 is coupled to the second fiber optic cable 220.

The second terminus of the second fiber optic cable 220 is coupled to a detector 230. Accordingly, the optical signal propagating in the second fiber optic cable 220 is received by the detector 230. The detector 230 is utilized to determine one or more various characteristics of the optical signal, the light source and/or the selective absorption medium. Such characteristics may include, but are not limited to, the amplitude (e.g., absorption), frequency (e.g., wavelength), phase, polarization, group delay, scattering, reflection dispersion (e.g., bandwidth), and/or the like characteristic.

Embodiments in accordance with the invention are advantageous in that the selective absorption cell 205 is relatively inexpensive and rugged. The apparatus comprises a first and second fiber optic cables 210, 220 and holey fiber optic cable 215. Thus, the small number of components advantageously provides a low unit cost. Further more, the similar dimensions of the holey fiber optic cable 215 and the first and second fiber optic cables 210, 220 allow for readily aligning the components. In addition, the adhesive, fusion splicing or the like processes utilized for attaching the holey fiber optic cable 215 and the first and second fiber optic cables 210, 220 also allow for readily maintaining the alignment of the components.

Embodiments in accordance with the invention are also advantageous in that the optical signal passing from the first fiber optic cable 210 to the holey fiber optic cable 215 and from the holey fiber optic cable 215 to the second fiber optic cable 220 is substantially coupled to the selective absorption medium. As a result, distortion and loss due to scattering and reflection are substantially reduced.

Referring now to FIG. 2B, a cross section view of an exemplary holey fiber optic cable 215, in one embodiment in accordance with the invention, is shown. As depicted in FIG. 2B, the holey fiber optic cable 215 comprises a primary core 250, a secondary core 255 surrounding the primary core 250, and a cladding 260 surrounding the secondary core 255. A plurality of voids (e.g., microstructures) 265 are formed within the secondary core 255. The plurality of voids 265 are adapted to be filled with the selective absorption medium.

In one embodiment in accordance with the invention, the voids 265 are elongated and run parallel to the fiber axis, and form a spatially periodic pattern when viewed in cross-section. The cladding region 260 has a lower index of refraction than the primary and secondary core regions 250, 255. Therefore, propagation of an optical signal is dominated by the index-guiding effect. The relatively small size of the void 265 provides for increased durability and robustness, against external bending, pinching, or squeezing of the holey fiber optical cable 215.

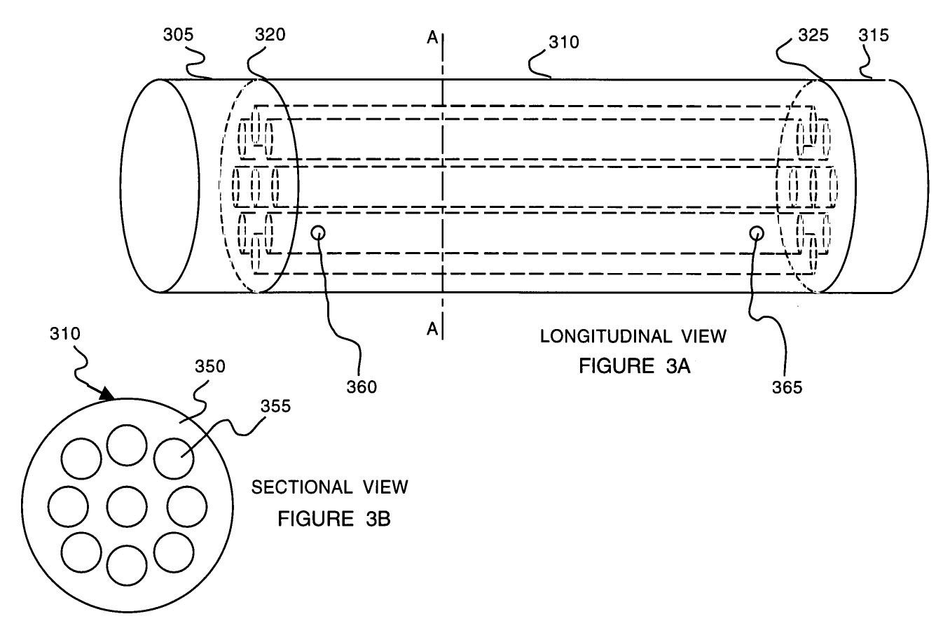

Referring now to FIG. 3A, an exemplary coupling of a first fiber optic cable 305, holey fiber optic cable 310 and second fiber optic cable 315 of an absorption environment cell, in one embodiment in accordance with the invention, is shown. As depicted in FIG. 3A, a terminus of the first fiber optic cable 305 is attached at location 320 to a first terminus of the holey fiber optic cable 310. The holey fiber optic cable 310 comprises a fiber having a plurality of voids (e.g., microstructures). The plurality of voids are adapted to be filled with a selective absorption medium, such as gas, liquid, or the like. The absorptive medium may be contained in the voids at a desired pressure. The second terminus of the holey fiber optic cable is attached at location 325 to a terminus of the second fiber optic cable 315, thereby sealing any selective absorption medium within the holey fiber optic cable 310.

In one embodiment in accordance with the invention, the holey fiber optic cable 310 may be attached to the first and second fiber optic cables 305, 315, respectively, utilizing an adhesive, such as a light transmitting epoxy. To accomplish this attaching, the first fiber optic cable 305, holey fiber optic cable 310 and second fiber optic cable 315 are respectively aligned and then an adhesive is applied there-between. Holey fiber optic cable 310 and first and second fiber optic cables 305, 315, respectively, are approximately of the same diameter, thus providing for ready alignment. Furthermore, the adhesive resists changes in alignment due to forces such as temperature, vibration, and the like.

In another embodiment in accordance with the invention, the holey fiber optic cable 310 is coupled at locations 320 and 325 to the first and second fiber optic cables 305, 315, respectively, utilizing a fusion splice. Holey fiber optic cable 310 and first and second fiber optic cables 305, 315, respectively, are approximately the same diameter, thus providing for ready alignment. Furthermore, the fusion splice process provides a self-aligning effect, whereby surface tension effects between the two fiber terminuses draw the fibers into substantial alignment. The fusion splice resists changes in alignment due to forces such as temperature, vibration, and the like.

When the selective absorption medium is combustible the fusion splice process is performed in an inert environment, such as argon. Alternatively, the adhesive attachment of the fibers is also well suited for use when the selective absorption medium is combustible.

Furthermore, the holey fiber optic cable and the first and second fiber optic cable are dissimilar in a number of respects. Such dissimilarities include: differences in materials from which the holey fiber optic cable and the first and second fiber optic cables are formed, the substantially solid core of the first and second fiber optic cables as compared with the holey fiber optic cable which has a plurality of voids; and/or the like. In such circumstances, the use of an adhesive readily provides for joining the dissimilar holey fiber optic cable 310 to the first and second fiber optic cables 305, 315.

In one embodiment in accordance with the invention, the selective absorption medium is introduced into the voids 355 prior to attaching the terminuses of the holey fiber optic cable 310 to the terminuses of the first and second fiber optic cables 305 and 315, respectively. In another embodiment in accordance with the invention, the first and second fiber optic cables 305, 315 are attached to the holey fiber optic cable 310 prior to filling the voids 355 with the selective absorption medium. In this embodiment in accordance with the invention, the selective absorption medium is then introduced into voids 355 via one or more fill holes 360. One or more evacuation holes 365 may also be provided to improve introduction of the selective absorption medium into the voids 355. The various fill and evacuation holes 360, 365 can be sealed after introduction of the selective absorption medium into the voids 355 of the holey fiber optic cable 310.

Referring now to FIG. 3B, a cross section view of an exemplary holey fiber optic cable 310, in one embodiment in accordance with the invention, is shown. As depicted in FIG. 3B, the holey fiber optic cable 310 comprises a core 350 having a plurality of voids (e.g., microstructures) 355. The voids 355 are elongated and run parallel to the fiber axis, and form a spatially periodic pattern when viewed in cross-section. The relatively small size of the voids 355 provides for increased durability and robustness against external bending, pinching, or squeezing of the holey fiber optical cable 310.

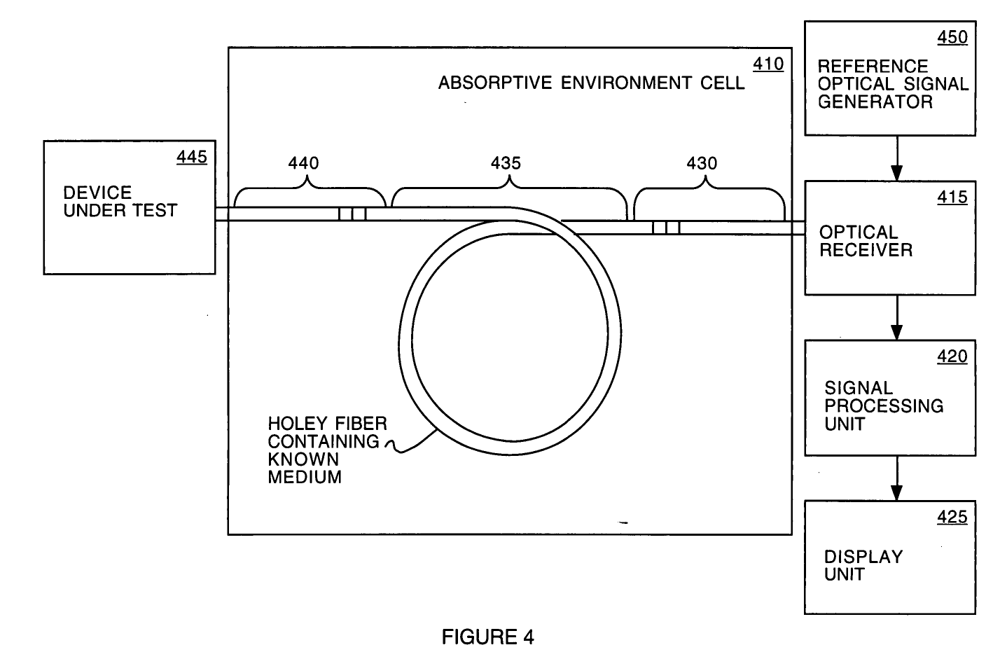

Referring now to FIG. 4, a block diagram of a system for performing spectroscopy, in one embodiment in accordance with the invention, is shown. As depicted in FIG. 4, the system comprises an absorptive environment cell 410, an optical receiver 415, a signal processing unit 420, and a display unit 425. A first terminus of the absorptive environment cell 410 is coupled to a first input of the optical receiver 415. An output of the optical receiver 415 is coupled to an input of the signal processing unit 420. An output of the signal processing unit 420 is coupled to an input of the display unit 425.

The absorptive environment cell 410 comprises a first fiber optic cable 430, a holey fiber optic cable 435 and a second fiber optic cable 440. The holey fiber optic cable 435 comprises a core having a plurality of voids. The voids are substantially uniformly distributed in the core. The voids are filed with a known selective absorption medium. A first terminus of the first fiber optic cable 435 comprises the first terminus of the absorptive environment cell 410. A second terminus of the first fiber optic cable 435 is attached to a first terminus of the holey fiber optic cable 435. A second terminus of the holey fiber optic cable 435 is attached to a first terminus of the second fiber optic cable 440. A second terminus of the second fiber optic cable 440 comprises a second terminus of the absorptive environment cell 410.

The second terminus of the absorptive environment cell 410 is coupled to a device under test 445. The device under test 445 transmits an optical signal having one or more unknown spectral properties. The second terminus of the absorptive environment cell 410 receives the unknown optical signal transmitted by the device under test 445. The unknown optical signal propagates along the second optic cable 440, the holey fiber optical cable 435 containing a known selective absorptive medium, and the first fiber optic cable 430.

The optical signal, upon propagation through the known selective absorptive medium contained in the holey fiber optic cable 435, is received at the first input of the optical receiver 415. In one embodiment in accordance with the invention, the optical receiver 415 comprises a photo-detector for measuring the intensity (e.g., power) of the received optical signal. In another embodiment in accordance with the invention, the optical receiver 415 comprises a heterodyne optical receiver. A first input of the heterodyne optical receiver is coupled to the first terminus of the absorptive environment cell 410. A second input of the heterodyne optical receiver may be coupled to the device under test 445 or a reference optical signal generator 440, or the like. Typically, the optical receiver 415 generates an electrical signal as a function of the received optical signal. The signal processing unit measures one or more characteristics of the received optical signal, such as the amplitude, frequency, wavelength, phase, polarization, group delay, scattering, reflection and/or bandwidth.

The signal processing unit 420 generates one or more display signals corresponding to the one or more determined characteristics. The one or more display signals cause the display unit 425 to display graphical information concerning the measurements of the received optical signal.

Fiber Bragg gratings are well-known in the art. The absorptive environment cell 410 may optionally include one or more fiber Bragg gratings. A pair of fiber Bragg gratings, spaced apart, but having similar wavelength characteristics, creates a resonant structure due to interactions between one or more wavelength-dependent optical mirrors created by the periodic changes in one or more locations in the reflective index of the holey fiber optic cable 435, or in the first and second fiber optic cables 430, 440. The periodicity is selected to correspond to one or more desired wavelengths where the interaction between the lightwave and absorptive medium is to be increased. Thus, the fiber Bragg gratings can be utilized to increase the effective interaction length of the holey fiber optic cable 435. Hence, the resonant structure enhances the interaction of the optical signal with the known absorptive medium contained in the holey optical fiber 435. To maximize the interaction of the light with the absorptive medium, the fiber Bragg gratings can be separated to maximize the holey fiber between them. The fiber Bragg gratings can also be utilizes to generate a secondary periodic transmission pattern for the purpose of creating known wavelength or dispersion signals. Chirped fiber and sampled fiber Bragg gratings are well-known in the art as a means to increased the wavelength range over which the fiber Bragg grating exhibits optical reflection. By using chirped fiber Bragg gratings, where the periodicity of the refractive index changes with distance along the fiber, the wavelength range of the secondary periodic transmission pattern can be increased. Similarly, the wavelength range, where the effective interaction length with the absorptive medium is increased, is also increased by using chirped Fiber Bragg gratings. Additionally, dielectric mirrors composed of alternating layers of material, such as TiO₂ and SiO₂ with different indices of refraction are well-known in the art and can be used to form the resonant cavity in a similar fashion as discussed with the fiber Bragg gratings. These mirrors are usually fabricated by well-known vacuum deposition processes. The mirrors are inserted in the path of the optical beam at fiber endfaces of the holey fiber or to the endfaces of fiber connecting to the holey fiber.

The system may optionally include a reference optical signal generator 450. The reference optical signal generator 450 is coupled to a second input of the optical receiver 415. In one embodiment in accordance with the invention, the reference optical signal generator 450 may be utilized as a reference signal for a heterodyne type optical receiver 415. In another embodiment, the reference signal generator 450 may be utilized to calibrate the optical receiver 415 and/or the signal processing unit 420.

In one embodiment in accordance with the invention, the system for performing spectroscopy is utilized to calibrate a device under test, such as a tunable laser. The tuning characteristics of the tunable laser source are determined from a measurement of absorption versus wavelength. In another embodiment in accordance with the invention, the system for performing spectroscopy is utilized to analyze the performance of a device under test, such as a wavelength filter used in an optical network. The performance is determined from a measurement of one or more complex measurements, such as dispersion.

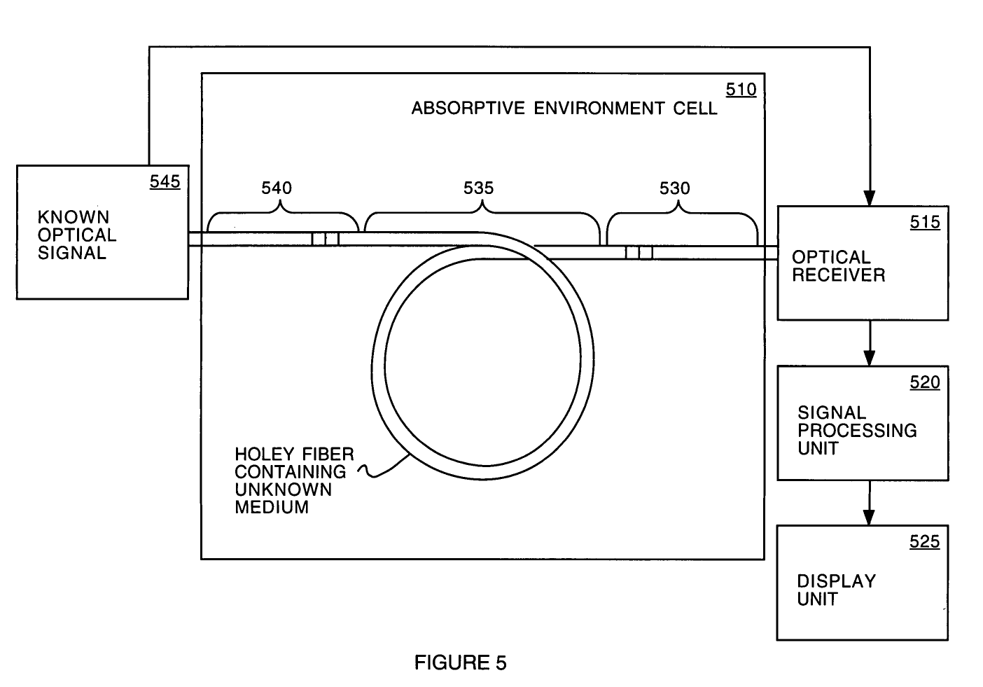

Referring now to FIG. 5, a block diagram of another system for performing spectroscopy, in one embodiment in accordance with the invention, is shown. As depicted in FIG. 5, the system comprises an optical source having known spectral properties 545, an absorptive environment cell 510, an optical receiver 515, a signal processing unit 520, and a display unit 525. An output of the optical source is coupled to a first terminus of the absorptive environment cell 510. A second terminus of the absorptive environment cell 510 is coupled to a first input of the optical receiver 515. An output of the optical receiver 515 is coupled to an input of the signal processing unit 520. An output of the signal processing unit 520 is coupled to an input of the display unit 525.

The absorptive environment cell 510 comprises a first fiber optic cable 530, a holey fiber optic cable 535 and a second fiber optic cable 540. The holey fiber optic cable 535 comprises a core having a plurality of voids. The voids are substantially uniformly distributed in the core. A first terminus of the first fiber optic cable 535 comprises the first terminus of the absorptive environment cell 510. A second terminus of the first fiber optic cable 535 is attached to a first terminus of the holey fiber optic cable 535. A second terminus of the holey fiber optic cable 535 is attached to a first terminus of the second fiber optic cable 540. A second terminus of the second fiber optic cable 540 comprises a second terminus of the absorptive environment cell 510.

Accordingly, the known optical signal generated by optical source 545 is coupled to the absorptive environment cell 510 including the holey fiber optic cable 535. The voids of the holey fiber optic cable 535 are filed with a substance under test (e.g., unknown medium), such as a chemical substance, a biological substance, or other material of interest. Hence, the known optical signal substantially propagates through the substance under test contained in the holey fiber optic cable 535.

The optical signal, upon propagation through the substance under test, is received at the first input of the optical receiver 515. In one embodiment in accordance with the invention, the optical receiver 515 comprises a photo-detector for measuring the intensity (e.g., power) of the received optical signal. In another embodiment in accordance with the invention, the optical receiver 515 comprises a heterodyne optical receiver. A first input of the heterodyne optical receiver is coupled to the first terminus of the absorptive environment cell 510. A second input of the heterodyne optical receiver may be coupled to the device under test 545 or a reference optical signal generator 540 or the like. Typically, the optical receiver 515 generates an electrical signal as a function of the received optical signal. The signal processing unit measures one or more characteristics of the received optical signal, such as the amplitude, frequency, wavelength, phase, polarization, group delay, scattering, reflection and/or bandwidth. In one embodiment in accordance with the invention, the system for performing spectroscopy is utilized to determine the identity and/or properties of the substance under test as a function of the one or more measured spectral properties.

The signal processing unit 520 generates one or more display signals corresponding to the one or more determined characteristics. The one or more display signals cause the display unit 525 to display graphical information concerning the measurements of the received optical signal and/or the identity of the substance under test.

The absorptive environment cell 510 may optionally include fiber Bragg gratings. The fiber Bragg gratings create one or more resonant structures using one or more mirrors having periodic changes in the reflective index of holey fiber optic cable 535 or the first and second fiber optic cables 530, 540. The periodicity is selected to correspond to one or more desired wavelengths. The fiber Bragg grating can be utilized to increase the effective length of the holey fiber optic cable 535. Hence, the resonant structure enhances the interaction of the optical signal with the substance under test contained in the holey optical fiber 535. The fiber Bragg gratings can also be utilized to generate a secondary periodic transmission pattern for the purpose of creating known wavelength or dispersion signals. Similarly, mirrors formed by alternating materials with different indices of refraction may be used to form one or more resonant cavities to increase the interaction between the optical signal and the substance under test.

The system may optionally include a means for coupling the optical source 545 directly to the optical receiver 515. In one embodiment in accordance with the invention, the optical source 545 may be utilized as a reference signal for a heterodyne type optical receiver 515. In another embodiment in accordance with the invention, the optical source 545 may be utilized to calibrate the optical receiver 515 and/or the signal processing unit 520.

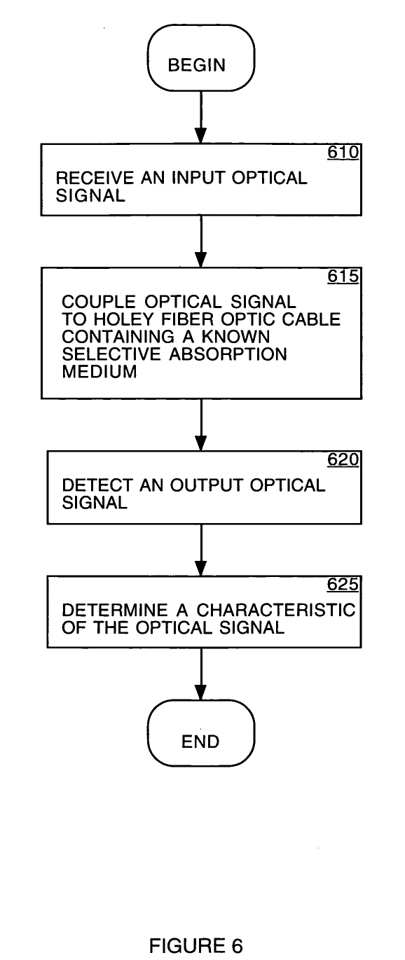

Referring now to FIG. 6, a flow diagram of a method of performing spectroscopy, in one embodiment in accordance with the invention, is shown. As depicted in FIG. 6, at 610 the present embodiment receives an optical signal at one terminus of a holey wave-guide. The holey wave-guide may comprise a holey optic cable, a holey planar wave-guide, a holey crystal guide, or the like. In one embodiment in accordance with the invention, the received optical signal may be a narrowband optical signal having a wavelength that varies as a function of time (e.g., swept frequency). The received optical signal may be generated by a tunable oscillator such as a tunable laser source (TLS). In another embodiment in accordance with the invention, the received optical signal may be broadband optical signal having a spectrum of approximately 10-50 nanometers. The received optical signal may be generated by a broadband oscillator such as an edge-emitting light emitting diode (EELED).

As received at 615, the optical signal is coupled to a holey wave-guide (e.g., holey fiber optic cable) such that it substantially propagates along a known selective absorption medium contained therein. In one embodiment in accordance with the invention, the selective absorption medium is a gas such as acetylene or hydrogen cyanide, a liquid or the like. The length of the holey wave-guide is selected to achieve a desired absorption result. In one embodiment in accordance with the invention, the absorption is approximately 1-10 dB or more.

As shown at 620, the optical signal, upon propagation through the holey wave-guide, is received by a detector. In one embodiment in accordance with the invention, the detector is a power meter, an optical spectrum analyzer, an optical component analyzer, or the like.

At 625, a characteristic of the optical signal is then determined as a function of the known selective absorption medium. In one embodiment in accordance with the invention, the method of spectroscopy may be utilized to characterize the tuning properties of a light source, such as a tunable laser. For example, the absorption valleys of the known selective absorption medium may be utilized to characterize the non-linearity of the tunable laser source. In another embodiment in accordance with the invention, the method of spectroscopy may be utilized to characterize the amplitude, frequency, wavelength, phase, polarization, group delay, scattering, reflection and/or bandwidth of the optical signal produced by the light source.

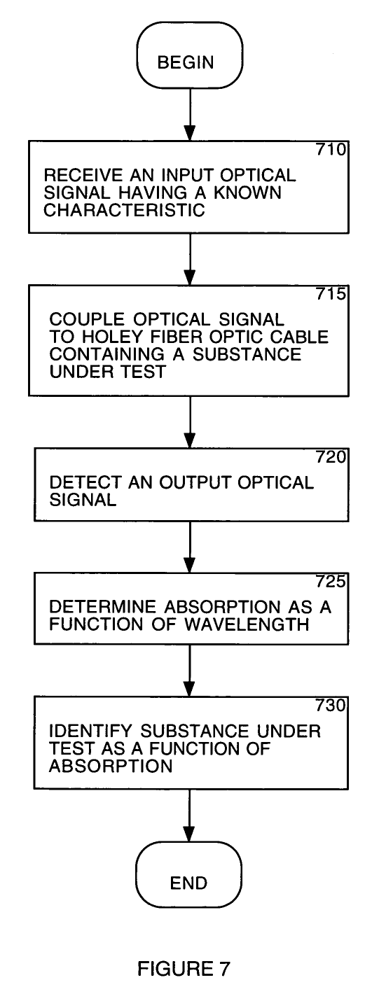

Referring now to FIG. 7, a flow diagram of a method of chemical analysis utilizing spectroscopy, in one embodiment in accordance with the invention, is shown. As depicted in FIG. 7, the method begins at 710 by receiving an optical signal having a known characteristic. The optical signal is received at one terminus of a holey wave-guide. The holey wave-guide may comprise a holey optic cable, a holey planar wave-guide, a holey crystal guide, or the like. In one embodiment in accordance with the invention, the received optical signal may be a narrowband optical signal having a wavelength that varies as a function of time (e.g., swept frequency). The received optical signal may be generated by a tunable oscillator such as a tunable laser source (TLS). In another embodiment in accordance with the invention, the received optical signal may be a broadband optical signal having a spectrum of approximately 10-50 nanometers. The received optical signal may be generated by a broadband oscillator such as an edge-emitting light emitting diode (EELED).

At 715, the known optical signal is coupled to a holey wave-guide (e.g., holey fiber optic cable) such that it substantially propagates along a substance under test contained therein. The substance under test may be a chemical substance, a biological substance, or other material of interest. The length of the holey wave-guide is selected to achieve a desired absorption product. In one embodiment in accordance with the invention, the absorption is approximately 1-10 dB or more.

As recited at 720, the known optical signal, upon propagation through the holey wave-guide, is received by a detector. In one embodiment in accordance with the invention, the detector is a power meter, an optical spectrum analyzer, or the like.

At 725, the absorption, experienced by the known optical signal is determined. For example, the amplitude of the optical signal may be determined as a function of wavelength. A corresponding plot of the amplitude versus the wavelength, of the output signal relative to the input signal, will exhibit distinct valleys of loss. Each selective absorption medium typically displays a unique set of absorption valleys over a spectrum of interest. Therefore, at 730, the substance under test can be identified based upon the absorption characteristics, or if the substance under test has known properties in advance, the measuring analyzer may be calibrated with the measured substance information.

The foregoing descriptions of specific embodiments in accordance with the invention have been presented for purposes of illustration and description. They are not intended to be exhaustive or to limit the embodiments in accordance with the invention to the precise forms disclosed, and obviously many modifications and variations are possible in light of the above teaching. The embodiments in accordance with the invention were chosen and described in order to best explain the principles of the invention and its practical application, to thereby enable others skilled in the art to best utilize the invention and various embodiments with various modifications as are suited to the particular use contemplated. It is intended that the scope of the embodiments in accordance with the invention be defined by the Claims appended hereto and their equivalents.

1. An optical wave-guide absorption cell, comprising:
a first wave-guide;
a holey wave-guide adapted to contain a selective absorption medium, wherein a first terminus of said holey wave-guide is coupled to a first terminus of said first wave-guide; and
a second wave-guide, wherein a first terminus of said second wave-guide is coupled to a second terminus of said holey wave-guide.

2. The optical wave-guide absorption cell according to claim 1, wherein said first terminus of said holey wave-guide is coupled to said first terminus of said first wave-guide utilizing a fusion splice.

3. The optical wave-guide absorption cell according to claim 1, wherein said first terminus of said holey wave-guide is coupled to said first terminus of said first wave-guide utilizing a light transmitting adhesive.

4. The optical wave-guide absorption cell according to claim 1, wherein said holey wave-guide comprises:
a core; and
a plurality of voids formed in said core.

5. The optical wave-guide absorption cell according to claim 4, wherein said holey wave-guide further comprises a fill hole formed in said core, adapted to introduce said selective absorption medium into said plurality of voids.

6. The optical wave-guide absorption cell according to claim 1, wherein:
said first wave-guide comprises a first fiber optic cable;
said holey wave-guide comprises a holey fiber optic cable; and
said second wave-guide comprises a second fiber optic cable.

7. A fiber optic absorption cell, comprising a holey fiber optic cable adapted for propagating an optical signal, wherein said holey fiber optic cable comprises:
a core;
a plurality of voids formed in said core;
a selective absorption medium contained in said plurality of voids; and
a fill hole formed in said core, adapted to introduce said selective absorption medium into said plurality of voids.

8. The fiber optic absorption cell according to claim 7, wherein said holy fiber optic cable further comprises an evacuation hole formed in said core, adapted to introduce said selective absorption medium into said plurality of voids.

9. The fiber optic absorption cell according to claim 7, further comprising a first fiber optic cable attached to a first terminus of said holey fiber optic cable, adapted to couple said optical signal from a light source to said holey fiber optic cable.

10. The fiber optic absorption cell according to claim 7, further comprising a second fiber optic cable attached to a second terminus of said holey fiber optic cable, adapted to couple said optical signal from said holey fiber optic cable to a detector.

11. A system for performing spectroscopy comprising:
a holey fiber optic cable containing a known absorptive medium coupled to an optical signal, wherein an optical signal substantially propagates in said known selective absorptive medium;
an optical receiver coupled to said holey fiber optic cable, wherein an electrical signal is generated as a function of said optical signal after propagating in said known selective absorptive medium; and
a signal processing unit coupled to said optical receiver wherein a characteristic of said optical signal after propagating in said known selective absorptive medium is measured as a function of said electrical signal.

12. The system for performing spectroscopy according to claim 11, wherein said holey fiber optic cable comprises one or more fiber Bragg gratings.

13. The system for performing spectroscopy according to claim 11, wherein said one or more fiber Bragg gratings comprise a resonant structure, wherein the effective interaction length of said holey fiber optic cable is increased.

14. The system for performing spectroscopy according to claim 11, wherein said one or more fiber Bragg gratings comprise a resonant structure, wherein a secondary period transmission pattern is generated.

15. The system for performing spectroscopy according to claim 11, further comprising a first fiber optic cable for coupling said optical signal to said holey fiber optic cable.

16. The system for performing spectroscopy according to claim 15, further comprising a second fiber optic cable for coupling said optical signal after propagating in said known selective absorptive medium from said holey fiber optic cable to said optical receiver.

17. The system for performing spectroscopy according to claim 16, wherein:
said first fiber optic cable comprise a first fiber Bragg grating; and
said second fiber optic cable comprises a second fiber Bragg grating.

18. The system for performing spectroscopy according to claim 17, wherein said first fiber Bragg grating and said second fiber Bragg grating comprise a resonant structure, wherein the effective interaction length of said holey fiber optic cable is increased.

19. The system for performing spectroscopy according to claim 17, wherein said first fiber Bragg grating and said second fiber Bragg grating comprise a resonant structure, wherein a secondary period transmission pattern is generated.

20. The system for performing spectroscopy according to claim 16, further comprising:
a first dielectric mirror coupled between said first fiber optic cable and said holey fiber optic cable; and
a second dielectric mirror coupled between said second fiber optic cable and said holey fiber optic cable.

21. The system for performing spectroscopy according to claim 20, wherein said first dielectric mirror and said second dielectric mirror comprise a resonant structure, wherein the effective interaction length of said holey fiber optic cable is increased.

22. The system for performing spectroscopy according to claim 20, wherein said first dielectric mirror and said second dielectric mirror comprise a resonant structure, wherein a secondary period transmission pattern is generated.

23. The system for performing spectroscopy according to claim 11, further comprising a reference optical signal generator coupled to said optical receiver, wherein said reference optical signal generator is utilized to calibrate said optical receiver.

24. A system for performing spectroscopy comprising:
an optical source for generating an optical signal having a known spectral characteristic;
a holey fiber optic cable containing a substance under test coupled to an optical signal, wherein said optical signal substantially propagates in said substance under test;
an optical receiver coupled to said holey fiber optic cable, wherein an electrical signal is generated as a function of said optical signal after propagating in said substance under test; and
a signal processing unit coupled to said optical receiver wherein a characteristic of said optical signal after propagating in said substance under test is measured as a function of said electrical signal.

25. The system for performing spectroscopy according to claim 24, wherein the substance under test is identified as a function of said characteristic.

26. The system for performing spectroscopy according to claim 24, wherein said holey fiber optic cable comprises one or more fiber Bragg grating pairs.

27. The system for performing spectroscopy according to claim 24, wherein said one or more fiber Bragg grating pairs comprise a resonant structure, wherein the effective interactive length of said holey fiber optic cable is increased.

28. The system for performing spectroscopy according to claim 24, wherein said one or more fiber Bragg grating pairs comprise a resonant structure, wherein a secondary period transmission pattern is generated.

29. The system for performing spectroscopy according to claim 24, further comprising a first fiber optic cable for coupling said optical signal from said optical source to said holey fiber optic cable.

30. The system for performing spectroscopy according to claim 29, further comprising a second fiber optic cable for coupling said optical signal after propagating in said substance under test from said holey fiber optic cable to said optical receiver.

31. The system for performing spectroscopy according to claim 30, wherein:
said first fiber optic cable comprise a first fiber Bragg grating; and
said second fiber optic cable comprises a second fiber Bragg grating.

32. The system for performing spectroscopy according to claim 31, wherein said first fiber Bragg grating and said second fiber Bragg grating comprise a resonant structure, wherein the effective interactive length of said holey fiber optic cable is increased.

33. The system for performing spectroscopy according to claim 31, wherein said first fiber Bragg grating and said second fiber Bragg grating comprise a resonant structure, wherein a secondary period transmission pattern is generated.

34. The system for performing spectroscopy according to claim 30, further comprising:
a first dielectric mirror coupled between said first fiber optic cable and said holey fiber optic cable; and
a second dielectric mirror coupled between said second fiber optic cable and said holey fiber optic cable.

35. The system for performing spectroscopy according to claim 34, wherein said first dielectric mirror and said second dielectric mirror comprise a resonant structure, wherein the effective interaction length of said holey fiber optic cable is increased.

36. The system for performing spectroscopy according to claim 35, wherein said first dielectric mirror and said second dielectric mirror comprise a resonant structure, wherein a secondary period transmission pattern is generated.

37. The system for performing spectroscopy according to claim 24, further comprising said optical source coupled to said optical receiver, wherein said optical signal is utilized to calibrate said optical receiver.

38. A method of optical spectrum analysis comprising:
propagating an optical signal along a holey fiber optic cable containing a known selective absorption medium; and
determining a characteristic of said optical signal as a function of said known selective absorption medium.

39. The method according to claim 38, wherein said optical signal comprises a narrowband optical signal having a wavelength varying as a function of time.

40. The method according to claim 39, further comprising receiving said optical signal from a tunable laser source (TLS).

41. The method according to claim 38, wherein said optical signal comprises a broadband optical signal.

42. The method according to claim 41, further comprising receiving said optical signal from an edge-emitting light emitting diode (EELED).

43. The method according to claim 38, wherein said characteristic comprises one or more properties selected from the group consisting of amplitude, absorption, frequency, wavelength, phase, polarization, group delay, scattering, reflection, dispersion and bandwidth.

44. The method according to claim 43, wherein said determining a characteristic of said optical signal is adapted to calibrate a measurement instrument as a function of said one or more properties.

45. The method according to claim 43, wherein said determining a characteristic of said optical signal is adapted to calibrate a property of a light source as a function of said one or more properties.

46. A method of spectroscopy comprising:
propagating a known optical signal along a holey fiber containing a substance under test;
determining an absorption, experienced by said optical signal, as a function of the wavelength; and
identifying said substance under test, as a function of said absorption.

47. The method according to claim 46, wherein said known optical signal comprises a tunable narrowband optical signal having a wavelength varying as a function of time.

48. The method according to claim 46, wherein said known optical signal comprises a broadband optical signal.

49. The method according to claim 46, wherein said substance under test is introduced into a plurality of voids formed in said holey fiber optic cable utilizing a fill hole having a first opening in said plurality of voids and having a second opening couplable to a source of said substance under test.
